(19) United States
(12) Patent Application Publication
(10) Pub. No.: US 2015/0019520 A1
(43) Pub. Date: Jan. 15, 2015

(54) SYSTEM AND METHOD FOR CONDUCTING SPATIO-TEMPORAL SEARCH USING REAL TIME CROWD SOURCING

(71) Applicant: AZ.MO.SH LTD., Netaim (IL)

(72) Inventors: Alex Avraham SHTAYGRUD, Suffern, NY (US); Avi Nathan, Haifa (IL); Asaf Mohr, Tel Aviv (IL)

(21) Appl. No.: 13/941,877

(22) Filed: Jul. 15, 2013

(51) Int. Cl. G06F 17/30

(52) U.S. Cl. CPC G06F 17/3087
USPC 707/706

(57) ABSTRACT

A system and a method for conducting spatio-temporal search using crowd source based real-time database are provided. The method may include: receiving from an inquiring user a combination of user related data (URD) related to at least one real time event, comprising at least one of: a temporal data, a spatial data and a contextual filter; generating a tempo-spatial contextual query based on the received URD; storing tempo-spatial contextual (TSC) data received from a crowd of users over a computerized network wherein said TSC is indicative of real time events; applying said query to said real time database for retrieving TSC data relevant to said query, wherein said search engine utilizes real time ranking from said crowd of users in applying the query; and presenting the relevant TSC data to the inquiring user.

### CROSS-REFERENCE TO RELATED APPLICATIONS

This application is a non-provisional patent application claiming priority from U.S. Provisional Patent Application No. 61/789,127, filed on Mar. 15, 2013, the content of which is incorporated herein by reference in its entirety.

### FIELD OF THE INVENTION

The present invention relates to the field of search engines and, more particularly, to event related search engines.

### BACKGROUND OF THE INVENTION

Search engine technology develops continuously, yet current search engines are mostly textually oriented. Currently available search engine associate results are with respective timestamp of posting and by user's fixed address. Search carried out using a mobile communication device may be further augmented by the knowledge of the devices' physical location. An important characteristic of the data over the internet is that any search is limited to the latest event of posting new data and is, therefore, limited to the past, rather than the present.

### SUMMARY OF THE INVENTION

Certain embodiments of the present invention provide a spatio-temporal search engine comprising a user interface arranged to receive at least user defined spatial data and user defined temporal data; and an application arranged to search for and retrieve at least one event having spatio-temporal characteristics that correspond to the user defined spatial and temporal data. The user interface is further arranged to present the retrieved events. These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of the invention and in order to show how it may be implemented, references are made, purely by way of example, to the accompanying drawings in which like numerals designate corresponding elements or sections.

In the accompanying drawings:

FIG. 1 is a high level schematic block diagram of a spatio-temporal search engine according to some embodiments of the invention;

FIG. 2 is a high level flowchart illustrating a spatio-temporal search method, according to some embodiments of the invention; and

FIG. 3 is a diagram illustrating an exemplary graphical user interface in accordance with some embodiments of the present invention.

### DETAILED DESCRIPTION OF THE INVENTION

With specific reference to the drawings in detail, it is stressed that the particulars shown are for the purpose of example and solely for discussing the preferred embodiments of the present invention, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

Events and social gatherings, such as parties, conventions, fairs and the like are usually characterized by at least a location and a time. Current search engine technologies typically allow users to specify a text input for a desired search, and the result of the search engine produces the text output representing the results of the search engine processing. Although today's search engines have implemented a lot of heuristics and sort the result data sometimes relevant to a location of the user based on IP address location, and even to previous user's search history and behavior, those search engines cannot do a good job for the entire class of information that users are constantly in search of Embodiments of the invention retrieve information relating to events in locations and within known times specified by the user, to overcome the deficiencies of known search engines.

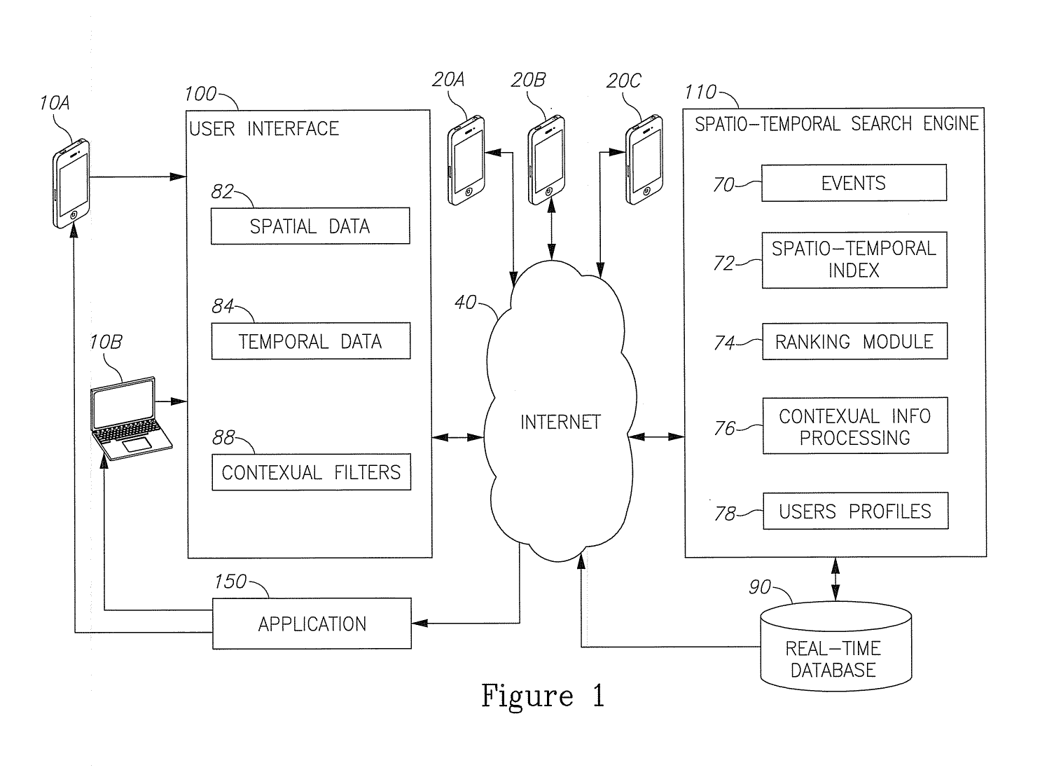

FIG. 1 is a high level schematic block diagram of a crowd based discovery tempo spatial platform that processes real-time events based, inter alia on dynamic ranking of the events as carried out by the crowd. The system may include a spatio-temporal search engine 110 which is in communication with a real-time database 90 which in turn is connected via the internet 40 to a plurality of networked user equipment (UE) such as smart telephones 20A-20C representing the crowd.

On the user side, a user interface 100 may be arranged to receive from a user, via a UE such as smart telephone 10A or laptop 1013, a plurality of user related data such as spatial data 82 (where the events may take place), temporal data 84 (when the events may take place), and contextual filters 88 (such as events preferences). These user-related data may be provided either explicitly or implicitly by the user. User interface 100 is configured to generate a query to search engine 110 based on the user related data.

Search engine 110 may be capable of receiving queries from user interface 100 and process them in light of other data received from the crowd 20A-20C and real-time database 90. In one embodiment, search engine 110 may include a spatio-temporal index 72 that implements a specified indexing scheme to the events 70 recorded on the real-time database 90. According to another embodiment, a ranking module 74 is configured to provide a dynamic ranking for the events which is derived in real time from crowd 20A-20C. According to another embodiment, user profiles 78 are further used to process the data relating to the events and to assist the ranking of them based on the dynamic crowd ranking. According to another embodiment, a contextual info processing module 76 is configured to associate specific context with specific events recorded and published on real time database 90. By using its modules, spatio-temporal search engine 100 may provide a comprehensive event discovery data in real time to the user over an application 150 possibly residing on smart telephone 10A or laptop 10B or any other UE.

In certain embodiments, spatio-temporal search engine 110 may track events in time and space. A time-space pointer respective of a user is received. Proximity of the time-space pointer and the event is determined. The time-space pointer includes associated time and space information. Space may be a physical location or a virtual space. Events may be provided to the user via a computerized user interface continuously or periodically. It is understood that space information may relate to a physical space in the real world, or a virtual space such as, but not limited to, a chat room. For example, a physical space in the real world may be a country, a state, a county, a city, a neighborhood, a street, a building, a convention, a venue and the like. Time information may include a time frame (i.e., begin time and end time), a specific date, a specific hour, holiday and the like. Receiving may be performed continuously or periodically. For example, a time-space pointer may include a coordinate associated space) and an exact date and time (associated time).

Further examples for spatial information may comprise a GPS location with the specified range of (X km or X miles), name of a city, name of a city district, name of a specific metropolitan area, name of a geographical region, county, country, or specific area range within two or more GPS locations. For example: mid-town Manhattan, Soho, Greater New York area, Israel, Europe, Scandinavian countries, etc. Further examples for temporal information may comprise any potential expression of time, representing the specific time region like: specific date, specific date range, specific time, specific time range, specified date-time range, weekday expressions, day(s), week(s), month(s),year(s), season(s), century, millennium, etc. (For example: today, tomorrow, day after tomorrow, Jan. 2, 2013, summer—meaning coming summer, summer 2014, 1st week of April, tonight, tomorrow afternoon, on Jan. 13, 2013 from 10 am to 4 pm, next week, this Sunday or next Sunday, etc.).

Spatio-temporal search engine 110 may handle real-life events, referred to herein also as events. Events typically have very specific geographical location (or geographical area) WHERE the event takes place (spatial parameters), and the real time range WHEN the event takes place (temporal parameters). Very often the event is also clearly associated with the specific venue of user's life activities (like hiking, nightclub, music concerts and the like) referred to herein as WHAT (content). Although WHEN, WHERE and WHAT parameters can be expressed in a text search, results of text search engines most likely consists of lots of noise, i.e., web pages that are completely irrelevant to the user's desired outcome. This requires sophistication on the user's part to refine the text/string search query over and over again to be able to find the desired event's information. It becomes even more complicated (or almost an impossible task) when the user wants to find events at any location but for a specific time or time range, or events of specific venues/interests at any location and/or at any time, or events of the specific location at any time, etc. Inconvenience in specifying real life search criteria and irrelevant results for the user is completely eliminated by spatio-temporal search engine 110.

For example, if a user's search phrase is “see Jazz concert this Sunday or next week in the Greater New York area”, it is not the text that will be searched upon but rather the context. That is, a logical search that matches the specified time ranges as well as potential one or many geographical areas as well as specific venue of user's preferences. Those searches obviously can be even further refined by entering a specific text input (like Blue Note Cafe), but those text search inputs are already entered within the spatio-temporal and content related frame of reference and are used to mere enhance the search. Spatio-temporal search engine 110 may provide accurate search results and reduces noise and annoyances of irrelevant information.

Further examples for content information may comprise any certain venue of interests. Such venues typically are not growing very often for each specific user. Once specifying them, the user can really increase a level of search results accuracy by order of magnitude by setting his preferences once to determine the WHAT (content) dimension of spatio-temporal search engine 110. This approach overcomes the difficulty of textual search engine, that typically users have multiple interests and very often their text search expressions are completely not related to a single subject matter (e.g., “hiking”), but rather user expressions should and can combine multiple user activities (e.g., “I want to have some fun today”, which by default includes a user's fun-meant interests like hiking and listening to Jazz music). Multiple queries like that are impossible to specify with the current search engines without completely confusing the linear search engines. Furthermore, users interests can be often refined by expressing user's mood or objectives, like planning vacation, wanting to go out, wanting to eat, etc. using user's mobile devices running time-scale engine application. These are completely ignored by current linear text search engines but are used by spatio-temporal search engine 110.

User interface 100 may be arranged to receive user related data associated with real time events and provide location, time and context of these events. In certain embodiments, there is no assumption of textual input of the time and space coordinates, although they can be expressed textually for a user's convenience. Locations ranges can be specified by regional/metropolitan pictograms, as well as other representations of geographical areas and obviously maps. The time can be specified textually, or visually using time gadgets, a user interface (UI), a graphical user interface (GUI), Web forms, or by touch using specific gestures designed for spatio-temporal search engine 110. Spatio-temporal search engine 110 may treat spatio-temporal and content parameters as one logical range in the continuous time-location space. A user is able to define a range in time and a range in space to define a scope for the events of interest. Contrary to textual searches, the time range can be also in terms humanly semantics, e.g., “late night” and “Soho” as part of “midtown Manhattan” and NYC. Time and location range can be further specified simultaneously like “tomorrow in Tel Aviv or Jerusalem”. Conventional search engines commonly falsely direct such queries, e.g., to a weather channel map, instead of to specific events that take place in those two cities tomorrow.

In some embodiments, spatio-temporal search engine 110 may resolve the static nature of the likes of Microsoft Outlook, Facebook events, Meetup events, etc., as events tend to have a dynamic rather than a static nature to them. In the prior art solutions, the events are static objects that are (in the best case scenario) sorted by date and time, and/or presented on the calendar of events as static objects. It is quite inefficient to use these traditional methods of consuming/looking for events. Accordingly, a client side time-scale engine allows a user to experience a travel through a time and space continuum where events are flying by a user's windshield, just like planets fly by the inter-galaxy ship which is traveling in time and space of the universe. Events are treated by the engine as objects in time and space and the most relevant to the user events in time and space found are presented.

Accordingly, a user could move not only in the space, for example a map, but also in time respective of the map, taking advantage that, in the computerized system, it is possible to go back in time with respect of a space. The universe traveled in can further be a specific universe, for example, the universe of Jazz music and, therefore, the space and time events shall be within that universe. Spatio-temporal search engine 110 may process/consume search results without forming explicitly new queries to a search engine, as it is done by prior art solutions. In essence, spatio-temporal search engine 110 may provide a continuous stream of events to a user, consumed by the time-scale engine on a client side. There is no longer need to query event's database numerous times while changing date/time or a desired location.

Spatio-temporal search engine 110 may further comprise a ranking module 74 arranged to rank events 70 according to user related data 82, 84, 88 by evaluating a degree to which each event 70 fits user defined spatial and temporal data 82, 84, 88 based also on the crowd 20A-20C.

Spatio-temporal search engine 110 may implement a crowd based event ranking, as there is a need for rating the events, and it should be rated by the crowd to get an objective rating that can be trusted (rating averaged over many users that have no bias). The concept of rating is widely used on the web (for example: Amazon's users rating products). However, events have unique characteristics that require rating at real time, typically before the event is over. Accordingly, ranking is performed by collecting or giving a higher weight to ranking of an event by people that have or are actually attending the event. Prior art page ranking gives little to no chance for good and interesting companies/events to climb to the top of the search list without an ad campaign or sophisticated search engine optimization tricks.

Companies that rate anything, for example, restaurants, pretty much portray stale ratings of the places without there being a big chance to the companies to improve that rating with the time. Therefore, according to an embodiment of the invention, the Intensity (Ranking) of an Event may be determined based for example on following factors: (A) Past events success/[Sentiment] (global, personal, social); (B) Event Satisfaction (crowd based); (C) Event attendance (crowd density, note, it is not always positive factor); (D) Event anticipation (crowd based); (E) Events registration (crowd based); (F) Events awareness (internet SE based and crowd based), virality of the events (number of FB shares, number of Likes, number of Views); and (G) Social event attendance (social graph based). According to an embodiment, the total rating may be calculated as a weighted sum of the individual (User Context Filters)ratings: Rating=2 (KA*RateA+KB*RateB+KC*RateC+KD*RateD+KE*RateE+KF*RateF+KG*RateG). All K parameters are personal weight dynamically calculated based on user's profile/attitude towards those categories.

The system initially assigns those parameters automatically, and later on self-tunes those parameters based on implicit and explicit feedback that the system gathers from the user. Hence, this is not a static rating of the place or event; on the contrary, it is an ever changing rating, especially while the event is taking place. Simply by attending events, the implicit attendance parameter will most likely affect the rating. Assigning certain priorities to the attendance of your favorite people or people of your circles will most likely affect the rating in real time as well, etc. Spatio-temporal search engine 110 may be fully or partially integrated in a web-based workspace.

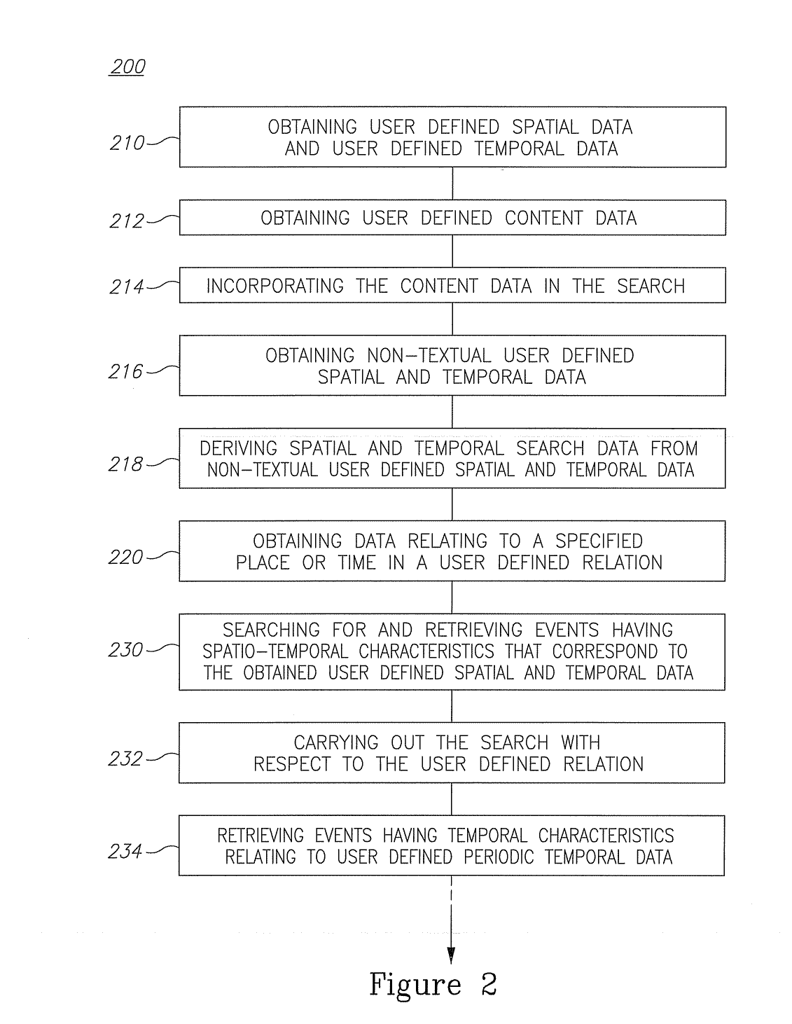

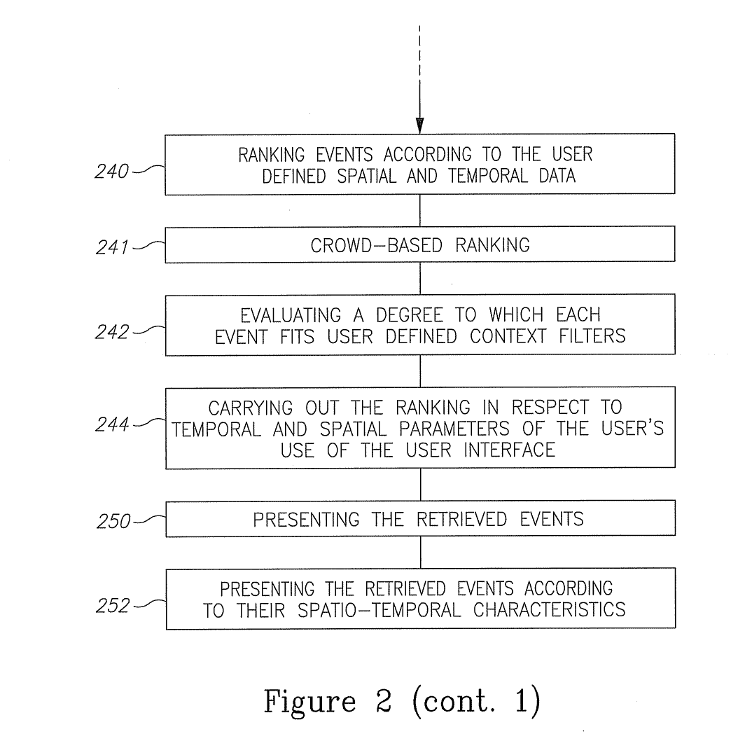

FIG. 2 is a high level flowchart illustrating a spatio-temporal search method 200, according to some embodiments of the invention. Method 200 may be partially or fully be carried out by at least one computer processor, e.g. by configuring computer readable programs to implement stages of method 200, the computer readable program being embodied with computer readable storage medium in a computer program product.

Method 200 may comprise obtaining at least user defined spatial data and user defined temporal data (stage 210), searching for and retrieving at least one event having spatio-temporal characteristics that correspond to the obtained user defined spatial and temporal data (stage 230) and presenting the retrieved events (stage 250). Method 200 may further comprise obtaining user defined contextual filters and incorporating the contextual filters in the search (stage 212). The user defined contextual filters may comprise user event preferences. Method 200 may further comprise carrying out data obtaining 210 in a non-textual manner (stage 216) and deriving spatial and temporal search data from them (stage 218). Method 200 may further comprise carrying out data obtaining 210 by obtaining data relating to a specified place or time in a user defined relation (stage 220) and carrying out the searching for and retrieving events having spatio-temporal characteristics that correspond to the obtained user defined spatial and temporal data with respect to the user defined relation (stage 232). In embodiments, the user defined temporal data may comprise user defined periodic temporal data, and the method 200 may further comprise carrying out the searching to retrieve at least one event having temporal characteristics relating to the user defined periodic temporal data (stage 234). In certain embodiments, searching for and retrieving events (230) may be carried out with respect to non-virtual events.

In some embodiments, presenting the retrieved events 250 may be carried out according to their spatio-temporal characteristics (stage 252), e.g., using a visual display interface. Method 200 may further comprise ranking events according to the user defined spatial and temporal data (stage 240) by evaluating a degree to which each event fits the user defined spatial and temporal data (stage 242). Ranking 240 may be carried out in further respect to temporal and spatial parameters of the user's use of the user interface (stage 244).

In some other embodiments, the method may include the following steps: receiving from an inquiring user a combination of user related data (URD) related to at least one real time event, comprising at least one of: a temporal data, a spatial data and a contextual filter; generating a tempo-spatial contextual query based on the received URD; storing tempo-spatial contextual (TSC) data received from a crowd of users over a computerized network wherein said TSC is indicative of real time events; applying said query to said real time database for retrieving TSC data relevant to said query, wherein said search engine utilizes real time ranking from said crowd of users in applying the query; and presenting the relevant TSC data to the inquiring user.

In accordance with some embodiments, the URD may derived implicitly without the inquiring user taking a deliberate action. This way, the inquiring user receives recommendation for events without initiating the query by explicit actions.

In accordance with some embodiments, the contextual filters may include at event preferences, users objectives or a combination of them. The method may also include a step of presenting the relevant TSC data as recommendations with indications of reasons for presenting said relevant TSC data. Optionally, the presented relevant TSC data may be further visually associated with at least one of: temporal data, spatial data, and dynamic ranking initiated by said crowd users.

In one embodiment of the method, the UDR is defined by one or more ranges of values, and the method may further comprise searching for and retrieving events based on said ranges.

According to some embodiments of the present invention, the system may further include a ranking module configured to rank events dynamically, based on the number of users recommending and/or participating in said events, user profiles associated with said users and utilizing the ranking in applying the query. After some training period, the system may offer the user to go to events that come up as relevant events based on his or her profile.

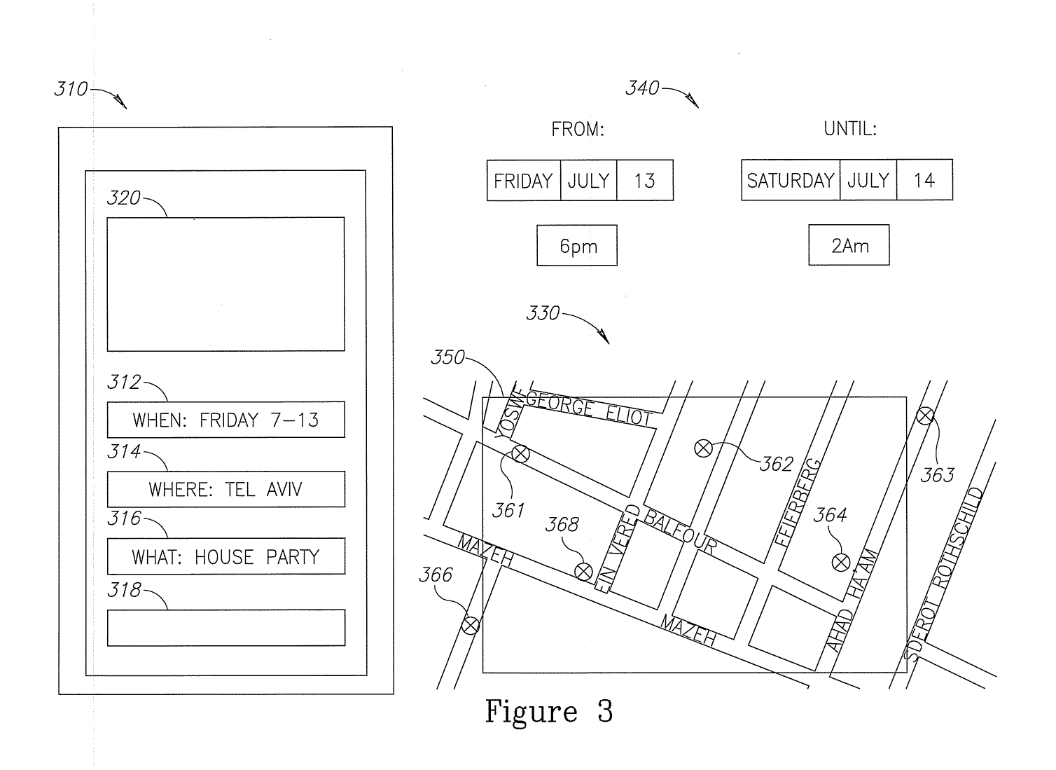

FIG. 3 is an exemplary diagram illustrating a non-limiting implementation of a graphical user interface (GUI) in accordance with some embodiments of the present invention. An exemplary user equipment (UE), such as a smart telephone 310, provides a plurality of spatio-temporal query fields such as WHEN 312, WHERE 314, WHAT 316 and an open field 318. In portion 320, output for the search may be presented.

In a non-limiting example, a user may wish to search for house parties in Tel Aviv within a temporal range from Friday, July 13 at 6 p.m. until Saturday, July 14 at 2 a.m. This time frame or range may be provided by selecting date and hour via a calendar-like feature 340 or something similar. A more specific location may be provided over a digital map 330 which may be further limited by a frame 350. The search results may be presented over map 330 by some visual indicators 361-368. Each one of the visual indicators may provide more data about the event (the house party) as provided by, for example, the crowd that have published the data regarding the event.

As will be appreciated by one skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The aforementioned flowchart and block diagrams illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of one or more inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that, where the claims or specification refer to “a” or “an” element, such reference is not be construed that there is only one of that element.

It is to be understood that, where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system comprising:
a user interface configured to: (a) receive from an inquiring user, a combination of user related data (URD) related to at least one real time event, comprising at least one of: a temporal data, a spatial data, and a contextual filter, and (b) generate a tempo-spatial contextual query based on the received URD;
a real time database configured to store tempo-spatial contextual (TSC) data received from a crowd of users over a computerized network, wherein said TSC is indicative of real time events;
a search engine configured to receive said query and to apply said query to said real time database for retrieving TSC data relevant to said query, wherein said search engine utilizes real time ranking from said crowd of users in applying the query; and
an application module configured to present the relevant TSC data to the inquiring user.

2. The system according to claim 1, wherein the URD are derived implicitly without the inquiring user taking a deliberate action.

3. The system according to claim 1, wherein the relevant TSC data is provided based on a user profile of the inquiring user and implicitly provided URD, without the inquiring user taking a deliberate action.

4. The system according to claim 1, wherein said contextual filters comprise at least one of: event preferences and users objectives.

5. The system according to claim 1, wherein the application module is further configured to present the relevant TSC data as recommendations with indications of reasons for presenting said relevant TSC data.

6. The system according to claim 5, wherein the presented relevant TSC data are further visually associated with at least one of: temporal data, spatial data, and dynamic ranking initiated by said crowd users.

7. The system according to claim 1, wherein said URD is defined by one or more ranges of values, and wherein the search engine is further configured to search for and retrieve at events based on said ranges.

8. The system according to claim 1, wherein the search engine further comprises a ranking module arranged to rank events dynamically, based on number of users recommending and/or participating in said events and user profiles associated with said users and wherein the search engine utilizes the ranking in applying the query.

9. A method comprising:
receiving from an inquiring user a combination of user related data (URD) related to at least one real time event, comprising at least one of: a temporal data, a spatial data and a contextual filter;
generating a tempo-spatial contextual query based on the received URD;
storing tempo-spatial contextual (TSC) data received from a crowd of users over a computerized network wherein said TSC is indicative of real time events;
applying said query to said real time database for retrieving TSC data relevant to said query, wherein said search engine utilizes real time ranking from said crowd of users in applying the query; and
presenting the relevant TSC data to the inquiring user.

10. The method according to claim 9, wherein the URD is derived implicitly without the inquiring user taking a deliberate action.

11. The method according to claim 9, wherein the relevant TSC data is provided based on a user profile of the inquiring user and implicitly provided URD, without the inquiring user taking a deliberate action.

12. The method according to claim 9, wherein said contextual filters comprise at least one of: event preferences and users objectives.

13. The method according to claim 9, further comprising: presenting the relevant TSC data as recommendations with indications of reasons for presenting said relevant TSC data.

14. The method according to claim 13, wherein the presented relevant TSC data are further visually associated with at least one of: temporal data, spatial data, and dynamic ranking initiated by said crowd users.

15. The method according to claim 9, wherein said UDR is defined by one or more ranges of values, and wherein the method further comprises searching for and retrieve at events based on said ranges.

16. The method according to claim 9, further comprising ranking events dynamically, based on number of users recommending and/or participating in said events and user profiles associated with said users and utilizing the ranking in applying the query.

17. A computer program product comprising a computer readable storage medium having computer readable program embodied therewith, the computer readable program comprising:
computer readable program configured to receive from an inquiring user a combination of user related data (URD) related to at least one real time event, comprising at least one of: a temporal data, a spatial data and a contextual filter;
computer readable program configured to generate a tempo-spatial contextual query based on the received URD;
computer readable program configured to store tempo-spatial contextual (TSC) data received from a crowd of users over a computerized network wherein said TSC is indicative of real time events;
computer readable program configured to apply said query to said stored real time data for retrieving TSC data relevant to said query, wherein said search engine utilizes real time ranking from said crowd of users in applying the query; and
computer readable program configured to present the relevant TSC data to the inquiring user.

18. The computer program product according to claim 17, wherein the URD is derived implicitly without the inquiring user taking a deliberate action.

19. The computer program product according to claim 17, wherein the relevant TSC data is provided based on a user profile of the inquiring user and implicitly provided URD, without the inquiring user taking a deliberate action.

20. The computer program product according to claim 17, wherein said contextual filters comprise least one of: event preferences and users objectives.

21. The computer program product according to claim 17, further comprising a computer readable program configured to present the relevant TSC data as recommendations with indications of reasons for presenting said relevant TSC data.

22. The computer program product according to claim 17, wherein the presented relevant TSC data are further visually associated with at least one of: temporal data, spatial data, and dynamic ranking initiated by said crowd users.

23. The computer program product according to claim 17, wherein said UDR is defined by one or more ranges of values, and wherein the computer program product further comprises a computer readable program configured to search for and retrieve at events based on said ranges.

24. The computer program product according to claim 17, further comprising a computer readable program configured to rank events dynamically, based on number of users recommending and/or participating in said events and user profiles associated with said users and to utilize the ranking in applying the query.
